(19) United States
(12) Patent Application Publication
(10) Pub. No.: US 2004/0182428 A1
(43) Pub. Date: Sep. 23, 2004

(54) Contact lens cleaning and storage device

(76) Inventor: Mark Philip Chepurny, Bradford (CA)

Correspondence Address: MARK PHILIP CHEPURNY, 52 SMITH STREET, BRADFORD, ON, L3Z 3C9, CA

(21) Appl. No.: 10/764,689

(22) Filed: Jan. 27, 2004

Related U.S. Application Data
(60) Provisional application No. 60/445,646, filed on Feb. 10, 2003.

(51) Int. Cl. B08B 3/00

(52) U.S. Cl. 134/89; 134/184; 134/201

(57) ABSTRACT

A Contact Lens Cleaning and Storage Device with left and right side cleaning reservoirs that, independent of each other, receives a quantity of clean solution and contact lenses, having agitating bosses, circular stops and drive system links on one quadrant, a drive system, a motor to operate the drive system, a bottom housing having holders to accommodate the cleaning reservoirs and motor, a top housing having circular cut outs to allow the top portion of the cleaning reservoirs to protrude, an on/off switch, a way to supply power to the motor, and caps for the cleaning reservoirs to prevent the cleaning solution from splashing out. A preferred embodiment includes the cleaning reservoir agitating bosses having the front side curved and the backside flat and a drive system comprising a drive arm and a drive cam.

### CROSS REFERENCE TO RELATED APPLICATIONS

U.S. PPA #60/445,646

Filing Date: Feb. 10, 2003

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND

1. Field of the Invention

This invention relates to contact lens cleaning and storage devices, specifically to an agitating type contact lens cleaning and storage device that cleans each lens in separate reservoirs.

### BACKGROUND

2. Description of Prior Art

It is imperative to know that ones contact lenses are cleaned properly because of the risks that unclean contact lenses carry. The risks range from eye ulcers to a complete loss of vision. Studies have shown that most contact lens wearers do not follow all the cleaning and disinfecting directions recommended by the doctor and the lens manufacturer. With ones eyesight at stake, it becomes extremely important that their contact lenses are cleaned and disinfected properly.

The traditional way of cleaning contact lenses, placing the lens in the palm of ones hand, applying cleaning solution and then rubbing with ones finger, is time consuming, inconsistent and there is a risk that the lenses will be damaged, therefore there is a need for a device that minimizes the amount of handling, safely and effectively cleans contact lenses, is easy to use and small enough to replace storage and travel cases.

Previously developed agitating type contact lens cleaning devices secure the contact lenses in a porous carrier, not allowing the lenses to move freely in the cleaning solution. This type of system does not allow the lens the ability to splash around in the cleaning solution and also prevents the lenses from coming in contact with gentle scrubbing surfaces, thereby not supplying the best clean possible. In addition, these devices rotate the porous carrier about a central axis within the cleaning solution. This arrangement offers little cleaning action of the lenses near the center of the axis where the force on the lens is small. Moreover, while trying to hold the lens in place there is a tendency for the lens to fold, thus preventing the lenses from attaining a desirable clean. Furthermore to secure the lens in the porous carrier, the user is required to go through several steps before the cleaning of the lenses can commence. The step required tend to be awkward and difficult, thereby defeating their purpose.

Other contact lens cleaning devices have been developed, however, they do not clean the contact lenses in separate reservoirs. This means the lenses will be cleaned in cleaning solution that has double the debris and contaminates. In addition, placing both contact lenses in a single reservoir weakens the strength of the cleaning solution and its effectiveness. This prevents the lenses from achieving the best possible clean.

Other devices have also been developed that merely vibrates the vessel containing the lenses and solution. Unfortunately, such vibratory units lack the ability to provide enough force on the lenses to be effective and thus yield little benefit in their cleaning and disinfecting ability.

Other devices have been developed, however, they are big and bulky and therefore do not replace ones storage and travel case.

Mechanically operated devices have also been developed, however, operating the device by hand is time consuming and thereby defeats their purpose.

### OBJECTS AND ADVANTAGES

Accordingly, several objects and advantages of my invention are:

(a) to provide a device that removes the time consuming, inconsistent process of cleaning and disinfecting contact lenses;

(b) to provide a device that cleans each contact lens in separate reservoirs, minimizing the amount of debris and contaminated cleaning solution the contact lenses are cleaned in;

(c) to provide a device that agitates the cleaning solution around the contact lens, allowing the lens to move about in the cleaning solution. This permits the lenses to contact gentle scrubbing surfaces, allowing the lenses to achieve a full and desirable clean;

(d) to provide a device that does not require the lenses to be placed in a carrier, this reduces the number of steps the user must perform when cleaning the lenses and also prevents the lenses from folding, allowing the lenses to achieve a full and desirable clean;

(e) to provide a device that is as simple and easy to operate as traditional contact lens storage and travel cases. For example, to use traditional contact lens storage and travel cases the user fills up the reservoirs with cleaning solution, places contact lenses in the reservoirs, then places the lids on the reservoirs;

(f) to provide a device that replaces ones contact lens storage and travel case-in other words, a device that can store contact lenses for a prolonged period of time and can be traveled without spilling any cleaning solution;

Further objects and advantages are to provide a device that is extremely compact so as to not take up counter space or to much room in ones luggage, is inexpensive to manufacture and reliable.

Other objects and advantages of the present invention will become apparent from the following descriptions, taken in connection with the accompanying drawings, wherein, by way of illustration and example, an embodiment of the present invention is disclosed.

### SUMMARY

In accordance with a preferred embodiment of the invention, there is disclosed Contact Lens Cleaning and Storage Device comprising: left and right side cleaning reservoirs that, independent of each other, receives a quantity of cleaning solution and a contact lens, having agitating bosses, circular stops and drive system links on one quadrant; a drive system; a motor to operate the drive system; a bottom housing having holders to accommodate the cleaning reservoirs and motor; a top housing having openings to accommodate the cleaning reservoirs; an on/off switch; and caps for the cleaning reservoirs to prevent the cleaning solution from splashing out. A preferred embodiment includes the clean reservoirs agitating bosses having the front side curved and the backside flat. The curved front side allows the cleaning solution to be scooped up when the cleaning reservoirs are rotating in their forward motion and the flat backside allows the cleaning solution to be circulated when the cleaning reservoirs are rotating in their backward motion; and a drive system that contains a drive arm and a drive cam. The drive arm loosely inserts into the right and left hand cleaning reservoirs drive system links and the drive cam loosely inserts into the drive arm and then presses onto the motor.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is an exploded view of the invention.

FIG. 2 is a perspective view of the invention.

FIG. 3 is a sectional view of the invention, taken through the section cut line A-A shown in FIG. 2

FIG. 4 is a plan view of the invention illustrating the devices operation and motion.

FIG. 5 is a perspective view of the cleaning reservoirs.

### REFERENCE NUMERALS IN DRAWINGS

10a right hand cleaning reservoir

10b left hand cleaning reservoirs

12 bottom cover

14 top cover

16 motor

18 drive system

20 on/off switch

22 battery

24 battery cover

26 caps

28 cleaning reservoir holders, found in bottom cover 12

30a drive system link right hand, found on right hand cleaning reservoir 10a

30b drive system link left hand, found on left hand cleaning reservoir 10b

32 circular openings, found in top cover 14

34 motor holder, found in bottom cover 12

36 switch hole, found in top cover 14

38 agitating bosses, found in cleaning reservoirs 10a and 10b

40 drive arm, found in drive system 18

42 drive cam, found in drive system 18

50 drive arm short boss, found on drive arm 40

52 drive arm long boss, found on drive arm 40

54 drive can big hole, found in drive cam 42

56 drive cam small hole, found in drive cam 42

60 curved front side, found on agitating bosses 38

62 straight back side, found on agitating bosses 38

70a right hand circular stop, found on right hand cleaning reservoir 10a

70b left hand circular stop, found on left hand cleaning reservoir 10b

72 circular bosses, found on top cover 14

80 clockwise motion

82 up and down motion

84 back and forth motion

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

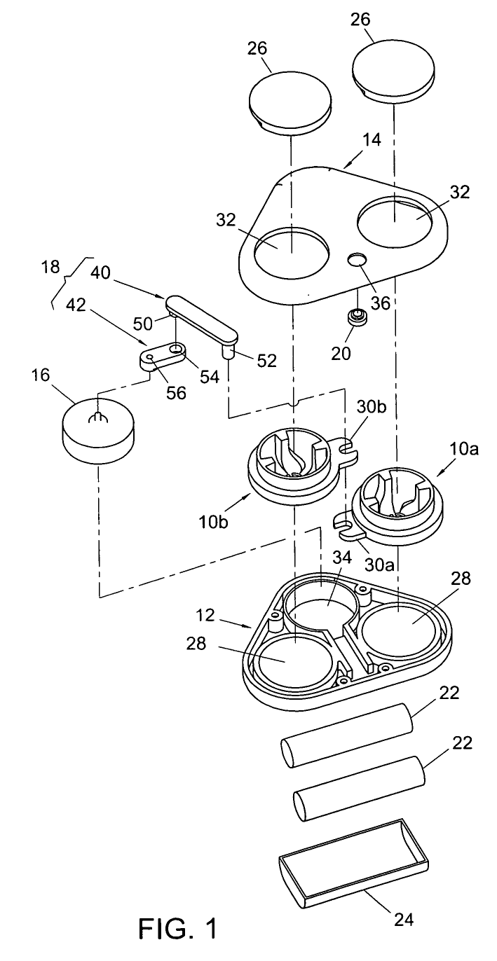

Referring to FIG. 1, a contact lens cleaning and storage device in accordance with the present invention is generally comprised of cleaning reservoirs 10a and 10b, a bottom cover 12, a top cover 14. The bottom cover 12 has cleaning reservoir holders 28 to accommodate the cleaning reservoirs 10a and 10b. The top cover 14 has circular openings 32 to accommodate the cleaning reservoirs 10a and 10b. The drive systems 18 comprises a drive arm 40 having a drive arm long boss 52 which loosely inserts into the cleaning reservoirs right and left hand drive system connecting links 30a and 30b and a drive cam 42 having a drive cam big hole 54 which loosely inserts into the drive arms short boss 50. The motor 16 gets pressed into the drive cam small hole 56. The motor 16 inserts into the bottom covers motor holder 34. The batteries 22 are contained underneath the front portion of the bottom cover 12 and covered by the battery cover 24. The batteries 22 get wired to the on/off switch 20 and motor 16, so that when the on/off switch 20 is pressed the batteries 22 supply power to the motor 16 which turns the drive cam 42 which turns the drive arm 40 which agitates the cleaning reservoirs 10a and 10b. The switch 20 gets secured to the top cover 14 and protrudes through the switch hole 36.

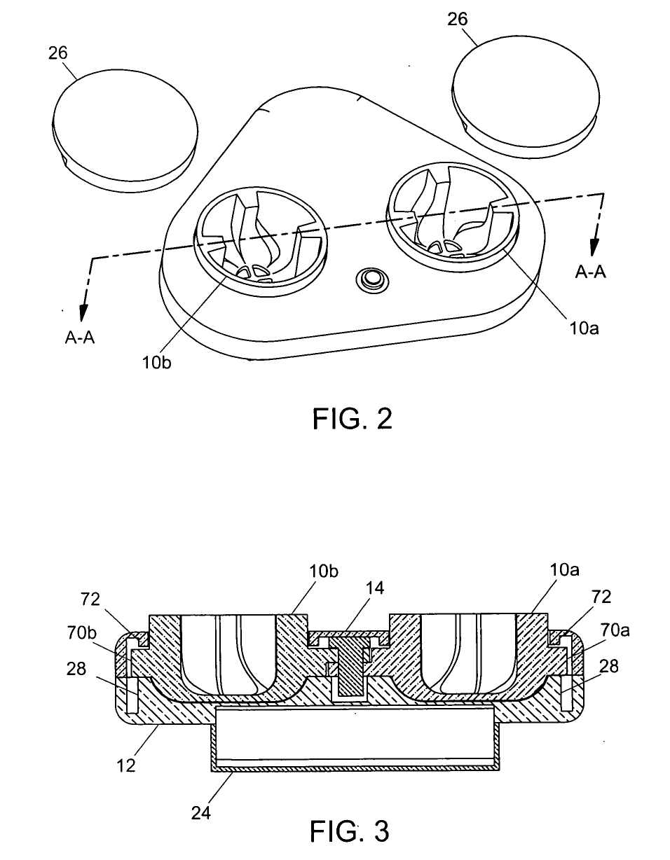

Turning now to FIG. 2, the caps 26 get pressed onto the cleaning reservoirs 10a and 10b so as to not allow the cleaning solution and contact lenses form splashing out once the device is in operation.

Turning now to FIG. 3, the cleaning reservoirs 10a and 10b have circular stops 70a and 70b which rest on the bottom covers cleaning reservoir holders 28, the top cover 14 has circular bosses 72 so that when the top cover 14 and the bottom cover 12 are assembled together the cleaning reservoirs 10a and 10b are fixed in place, while still providing room for the cleaning reservoirs 10a and 10b to rotate freely.

### OPERATION OF THE PREFERRED EMBODIMENTS

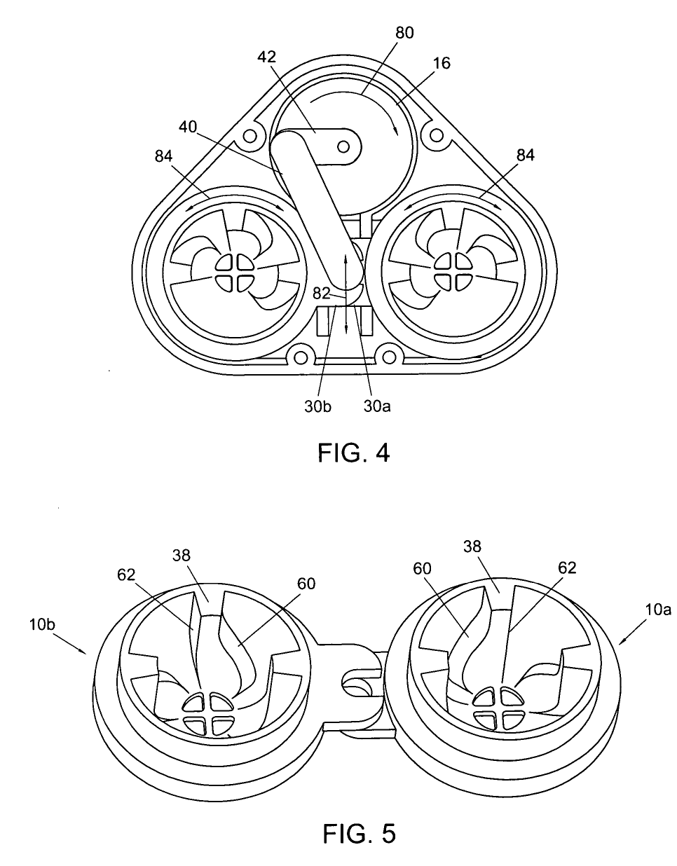

Turning now to FIG. 4, the user places contact lenses and cleaning solution into cleaning reservoirs 10a and 10b, then the caps 26 (not shown here but shown in FIG. 2 of my above patent) are pressed onto the cleaning reservoirs 10a and 10b so as to not allow the cleaning solution and contact lenses form splashing out once the device is in operation, when the on/off switch 20 (not shown here but shown in FIG. 1 of my above patent) is pressed the motor 16 is supplied with power, this causes the drive cam 42 to rotate in a clockwise motion 80, because one end of the drive arm 40 is loosely inserted into the drive cam 42 and the other end of the drive arm 40 is loosely inserted into the cleaning reservoirs drive system links 30a and 30b the bottom part of the drive arm 40 moves in an up and down motion 82, because the drive arm 40 is loosely inserted into the cleaning reservoirs drive system links 30a and 30b the up and down motion 82 cause the cleaning reservoirs 10a and 10b to agitate in a back and forth motion 84,

Turning now to FIG. 5, the cleaning reservoirs 10a and 10b have agitating bosses 38 that consist of a curved front side 60 and a straight back side 62; the curved front side 60 allows the cleaning solution to be scooped up when the cleaning reservoirs 10a and 10b are rotating in their forward motion and the straight back side 62 allows cleaning solution to be circulated when the cleaning reservoirs 10a and 10b are rotating in their backward motion.

### CONCLUSION, RAMIFICATIONS, AND SCOPE

Accordingly, the reader will see that the contact lens cleaning and storage device of this invention will:

remove the time consuming, inconsistent process of cleaning and disinfecting contact lenses.

offer a superior clean since the design of the agitating bosses provides a forceful agitation of the cleaning solution.

provides a superior clean since the device is designed to agitate the cleaning solution around the contact lenses, this allows the lenses to freely move about in the solution which in turn allows the lenses to contact gentle scrubbing surfaces.

allow the lenses to achieve a full and desirable clean since the device of this invention does not require the lenses to be held in a carrier, thus folding of the lenses is prevented,

In addition,

cleans each contact lens in separate reservoirs, this minimizes the amount of debris and contaminated cleaning solution the contact lenses are cleaned in.

does not require the lenses to be placed in a carrier, this reduces the number of steps the user must perform before cleaning of the lenses can begin.

is as simple and easy to operate as traditional contact lens storage and travel cases, for example, to use traditional contact lens storage and travel cases the user fills up the reservoirs with cleaning solution, places contact lenses in the reservoirs and places caps on reservoirs.

will replaces ones contact lens storage and travel case-in other words, the user can store contact lenses for a prolonged period of time and it can be traveled without spilling any cleaning solution.

minimizes the amount of handling by the user, this minimizes the risk of damaging the lenses.

is extremely compact so as to not take up counter space or to much room in ones luggage

is inexpensive to manufacture and reliable.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Contact Lens Cleaning and Storage Device comprising:
Cleaning reservoirs that receive a quantity of clean solution and contact lenses, having agitating bosses and drive system links;
a drive system to operate the cleaning reservoirs;
a motor to operate the drive system;
a bottom housing having holders to accommodate the cleaning reservoirs and motor;
a top housing having circular opening to accommodate the cleaning reservoirs; and
caps for the cleaning reservoirs to prevent the cleaning solution from splashing out.

2. Contact Lens Cleaning and Storage Device as claimed in claim 1 wherein said agitating bosses having a curved front side and a flat backside; said curved front side allows the cleaning solution to be scooped up when said cleaning reservoirs are rotating in their forward motion and said flat backside allows the cleaning solution to be circulated when said cleaning reservoirs are rotating in their backward motion.

3. Contact Lens Cleaning and Storage Device as claimed in claim 1 wherein said drive system comprises; a drive arm and a drive cam, said drive arm is in the shape of a flat bar and has circular bosses on either end and said drive cam is in the shape of a flat bar with holes in either end.

4. Contact Lens Cleaning and Storage Device as claimed in claim 1 wherein said Cleaning reservoirs drive system links are u-shape and located on one quadrant of said cleaning reservoirs.

5. Contact Lens Cleaning and Storage Device as claimed in claim 1 wherein said Cleaning reservoirs are cylindrical in shape with rounded bottoms
